(19) United States
(12) Patent Application Publication
(10) Pub. No.: US 2008/0125040 A1
(43) Pub. Date: May 29, 2008

(54) Location discovery using bluetooth

(75) Inventor: Nicholas R. Kalayjian, San Carlos, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: Apple Computer, Inc.

(21) Appl. No.: 11/606,850

(22) Filed: Nov. 29, 2006

(51) Int. Cl. H04B 7/00

(52) U.S. Cl. 455/41.2

(57) ABSTRACT

A method and system for locating objects using a Bluetooth communications protocol is provided. A first device can be paired, using a Bluetooth protocol, with one or more second devices. In that case, the first device is referred to as the master device and one or more second devices are referred to as the slave devices. When prompted by a user, the master device can transmit a signal to one of the slave devices. The slave device can then take a predetermined action to attempt to guide a user to its location. For example, the slave device can transmit a return signal to the master device or emit auditory or visual alerts itself.

### BACKGROUND OF THE INVENTION

The present invention relates to wireless communications. More particularly, the present invention relates to locating physical devices using a Bluetooth® communications protocol.

Small items get lost. These items, such as keys or remote controls, often are close by, but can be out of sight. The resulting search for such objects is tedious, annoying and sometimes unsuccessful if the objects are never found. Some devices have been designed to aid users in locating lost objects. Such systems traditionally transmit a radio frequency signal to a transceiver which reacts by broadcasting an audio or visual alarm.

Traditional location discovery systems have several drawbacks. These systems commonly involve permanent base units, which broadcast a signal to the lost object. Such base units take up space and often offer no other functions. The transmitted signal, which is essentially an alert to trigger an alarm, is typically the only type of signal being broadcast. Often this signal is a one way signal to the lost device, which can emit a sound, flash a light, etc. to try and let the user know where the device is.

An example of such a system involves a base station and multiple portable receivers. When a user pushes a button on the base station, the corresponding receiver emits an audible alarm to notify the user of its location. In this type of system, the base station may need a separate circuit in order to generate and transmit a signal to each receiver.

These devices often require dedicated electronic hardware to transmit or receive an alert signal. This extra hardware can increase the cost, weight, size and power consumption of such devices. It is therefore desirable to provide an improved way to aid people in locating misplaced objects.

Further limitations and disadvantages of conventional and traditional approaches will become apparent to one of ordinary skill in the art, through comparison of such systems with some aspects of the present invention as set forth in the remainder of the present application with reference to the drawings.

### SUMMARY OF THE INVENTION

A method and system for locating objects using a Bluetooth communications protocol is provided. A first device can be paired, using a Bluetooth protocol, with one or more second devices. In that case, the first device is referred to as the master device and one or more second devices are referred to as the slave devices. When prompted by a user, the master device can transmit a signal to one of the slave devices. The slave device can then take a predetermined action to attempt to guide a user to its location. For example, the slave device can transmit a return signal to the master device or emit auditory or visual alerts itself.

### BRIEF DESCRIPTION OF THE DRAWINGS

The above and other features of the present invention, its nature and various advantages will be more apparent upon consideration of the following detailed description, taken in conjunction with the accompanying drawings.

FIG. 1 is a simplified schematic diagram showing how software in a Bluetooth device is organized.

FIG. 2 is a simplified schematic diagram of an exemplary hardware implementation of a Bluetooth device.

FIGS. 3a and 3b are illustrations of an embodiment of a location discovery system in accordance with the principles of the present invention.

FIG. 4 is an illustration of an embodiment of a device which can be operated in accordance with the principles of the present invention.

FIGS. 5a and 5b are illustrations of another embodiment of a device which can be operated in accordance with the principles of the present invention.

FIG. 6 is an illustration of a sample screenshot of a user interface of a device which can be operated in accordance with the principles of the present invention.

FIG. 7 is an illustration of an additional screenshot of a user interface of a device which can be operated in accordance with the principles of the present invention.

FIG. 8 is an illustration of another screenshot of a user interface of a device which can be operated in accordance with the principles of the present invention.

FIG. 9 is an illustration of an embodiment of a location discovery system in accordance with the principles of the present invention.

FIG. 10 is a flowchart of a method for locating an object in accordance with the principles of the present invention.

FIG. 11 is a flowchart of another method for locating an object in accordance with the principles of the present invention.

### DETAILED DESCRIPTION OF THE INVENTION

Bluetooth wireless technology has the potential to revolutionize personal connectivity by providing users with freedom from wired connections. Bluetooth is a standard, or protocol, designed to provide a low cost radio solution that creates wireless links between mobile computers, mobile phones and other portable and handheld devices. Two features of Bluetooth that can be used in accordance with the principles of the present invention are Bluetooth's low power consumption and the ability of Bluetooth devices to automatically communicate with other Bluetooth devices once they become within range of each other.

Bluetooth wireless technology is an international, open standard for allowing intelligent devices to communicate with each other through wireless, short-range communications. This technology allows any sort of electronic equipment, from computers and cell phones to keyboards and headphones, to make its own connections, without wires or any direct action from a user. Bluetooth is already incorporated into numerous commercial products including laptop computers, PDAs, cell phones and printers, with more products coming out every day.

Bluetooth is referred to as a frequency hopping spread spectrum (FHSS) radio system that operates in the 2.4 GHz unlicensed band. What this means is that Bluetooth transmissions change frequencies based on a sequence which is known to both the transmitter and the receiver. According to the current standard, Bluetooth transmissions use 79 different frequencies ranging from 2.404 GHz to 2.480 GHz. Bluetooth's low power transmissions allow a typical range of about 10 meters or roughly 30-40 feet. This range can vary from about 1 meter to 100 meters depending on the amount of power used by the device for Bluetooth.

Bluetooth devices connect to each other to form networks known as piconets. A piconet includes two or more devices which are synchronized to a common clock signal and hopping sequence. What this means is that the two devices are operating using two characteristics that can vary from device to device but are matched in this instance to help form the network. Any other devices that connect to a given piconet must also have the same clock signal and hopping sequence. The synchronized clock and hopping sequence are derived using the clock signal of one of the devices on the piconet. This device is often referred to as the “master” device while all other devices on the piconet are referred to as “slave” devices. Each piconet includes one master device and up to seven slave devices. Moreover, Bluetooth devices can belong to more than one piconet.

When two Bluetooth devices initially connect, they first share some general information (e.g. device name, device type, etc.) with each other. In order to enhance the connection, the devices can establish a trusted relationship by using a secret passkey. This passkey is typically provided by a user or stored on memory in a device. According to the Bluetooth standard, the process of establishing this trusted relationship is called pairing. Once two devices are paired, they will typically share more information and accept instructions from one another.

Using technology available today, Bluetooth devices can operate with a maximum data throughput of approximately 2.1 Mbit/s (Megabits-per-second), but the principles of the present invention can also be applied to devices operating at other rates, particularly if the Bluetooth standard evolves. This maximum throughput is shared between all devices on a piconet meaning that if more than one slave device is communicating with the master, the sum of all communications must be less than the maximum data throughput.

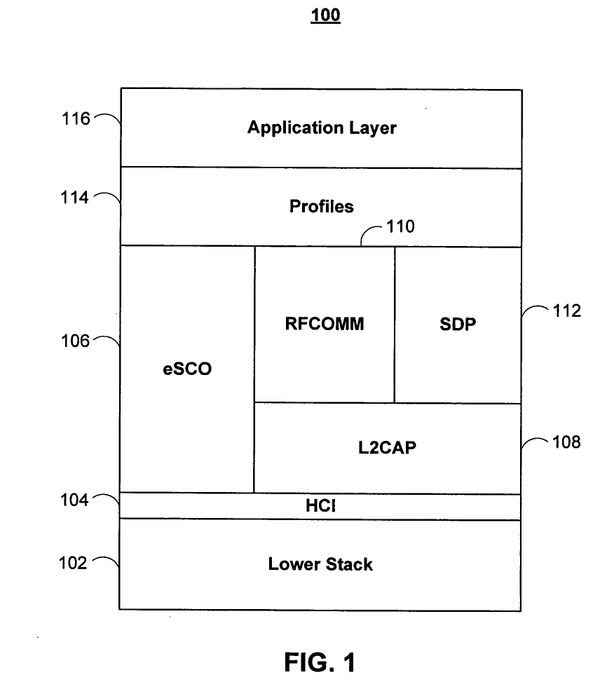

The Bluetooth standard includes a published software framework. The shared framework is called the Bluetooth Protocol Stack and includes the different parts of software required to implement Bluetooth communications. FIG. 1 is a simplified schematic diagram of an exemplary Bluetooth Protocol Stack 100. The most low-level software is included in Lower Stack 102. This section includes code to generate/receive radio signals, correct transmission errors and encrypt/decrypt transmissions, among other things. The Host Controller Interface (HCI) 104 is a standardized interface between the low-level Bluetooth functions and applications. Often, the HCI layer will represent a division between the Lower Stack 102 functions handled by a dedicated Bluetooth processor and the rest of the functions handled by an application-specific processor.

The Extended Synchronous Connection-Oriented (eSCO) 106 layer is used to implement dedicated communication channels, commonly used for voice data, in between the Lower Stack 102 and high-level applications. The Logical Link Control and Adaptation Protocol (L2CAP) 108 layer combines and repackages the data transmitted and received by the multiple higher-level applications. The L2CAP 108 layer combines all of these different communications into one data stream that can interface with Lower Stack 102 The RFCOMM 110 layer emulates the protocol used by serial connections. This allows software designers to easily integrate Bluetooth into existing applications which previously used a serial connection. The Service Discovery Protocol (SDP) 112 layer is used by devices to provide information about what services (or functions) each device offers and how other devices can access those services through Bluetooth. The Profiles 114 layer allows a device to identify itself as a member of a generic group of devices with a predefined set of functions. For example, a device complying with the headset profile will support predefined methods relating to audio communications. The Application Layer 116 contains programs that implement the useful tools created by all of the other layers. By writing different programs for Application Layer 116, software developers can focus on new uses of the Bluetooth functionality without having to rewrite the code which controls the underlying communication tasks.

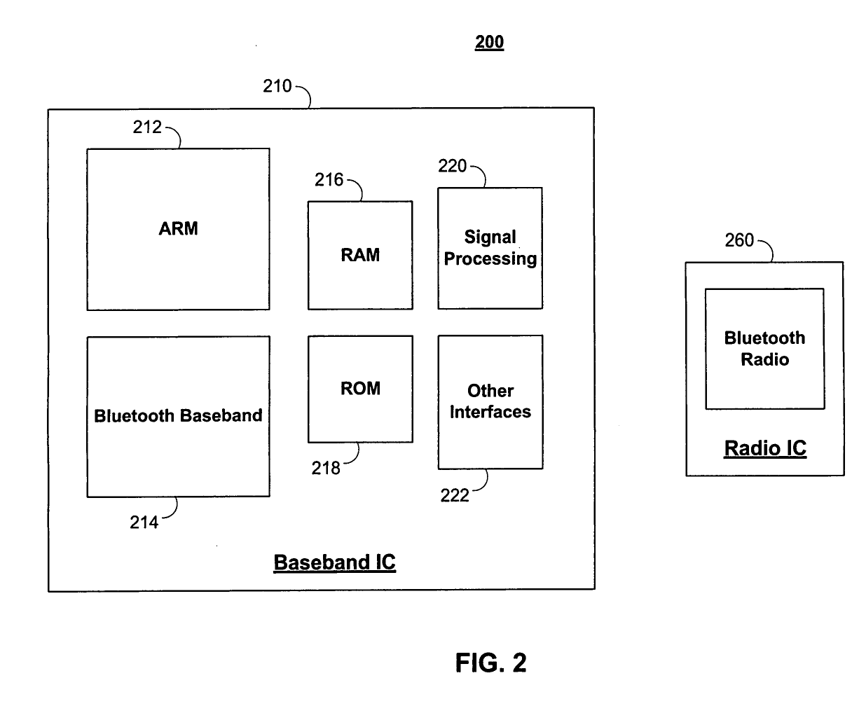

Bluetooth hardware is typically implemented using highly integrated systems that can consist of one or more complex integrated circuits (IC). FIG. 2 is a block diagram that illustrates one exemplary implementation of Bluetooth hardware. In this implementation, the system has been divided into two ICs, baseband integrated circuit 210 and radio integrated circuit 260.

The baseband IC can include central processor 212, Bluetooth baseband processor 214, random access memory (RAM) 216, read-only memory (ROM) 218, signal processing circuitry 220 and interface circuitry 222. Central processor 212 can be, for example, an ARM processor that performs higher-level application functions. Bluetooth baseband processor 214 can perform Bluetooth specific functions, such as eSCO 106, L2CAP 108, RFCOMM 110 and SDP 112. RAM 216 and ROM 218 can be used to store data. Signal processing circuitry 220 can be used to filter or decompress data. Interface circuitry 222 can allow the device to communicate over other interfaces besides Bluetooth, such as the Universal Serial Bus (USB) interface.

Transmitting and receiving radio signals can be implemented in a separate Radio IC 260. This separate circuit approach is often desirable because of the precision necessary for generating high-frequency radio signals. By incorporating all of the other less precise, non-radio circuits into the Baseband IC, this implementation offers a small, low power, low cost solution.

Persons of ordinary skill in the art will appreciate that any references to Bluetooth protocols in this application encompass both existing protocols as well as Bluetooth protocols that may be developed in the future.

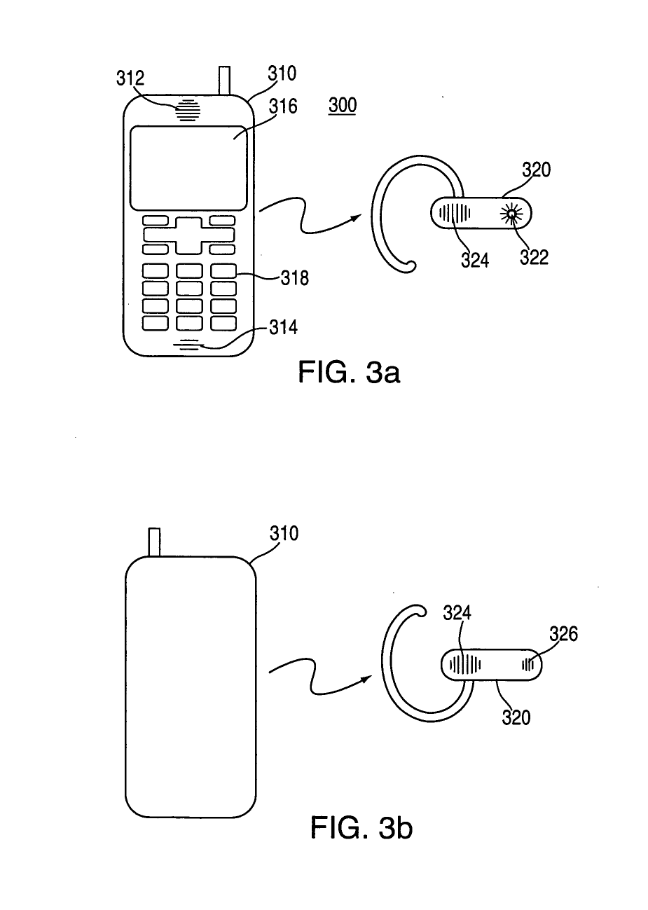

FIGS. 3a and 3b show location discovery system 300 which includes first device 310 and second device 320. FIG. 3a is a front view of system 300, and FIG. 3b is a rear view of system 300. Devices 310 and 320 can be any devices capable of communicating using a Bluetooth protocol but in this instance are cellular phone 310 and headset 320. Devices 310 and 320 can have additional uses (e.g. telephone, audio headphones, music player, etc.) unrelated to locating other devices. It is contemplated that these other functions may use a Bluetooth communications protocol in which case much of the hardware related to the present invention might be able to serve multiple functions. This feature, if implemented, might lower cost and power consumption for devices 310 and 320 even further.

Device 310 can be, for example, a Bluetooth capable cellular phone. Cell phone 310 can include speaker 312, microphone 314, display screen 316 and keypad 318. As described in more detail below, cell phone 310 can also be referred to as master device 310.

Second device 320 can be, for example, a Bluetooth enabled wireless phone headset. FIG. 3b shows an additional view of headset 320. Headset 320 can include light 322, speaker 324, and microphone 326. Light 322 can be activated to attempt to guide a user to its location. Light 322 can also be used to indicate the operational status of the device. For example a flashing light could signify a low battery condition. Headset 320 can have speaker 324 to emit sounds operable to guide a user to its location. In one embodiment, speaker 324 can be a single speaker that can broadcast sound to both sides of headset 320. In another embodiment, speaker 324 can include two separate speakers. One speaker could broadcast sound into a user's ear for cellular operation, and another speaker could broadcast sound into the area around headset 320 for location discovery. Headset 320 can also include microphone 326 to facilitate cellular operation. As described in more detail below, headset 320 can also be referred to as slave device 320.

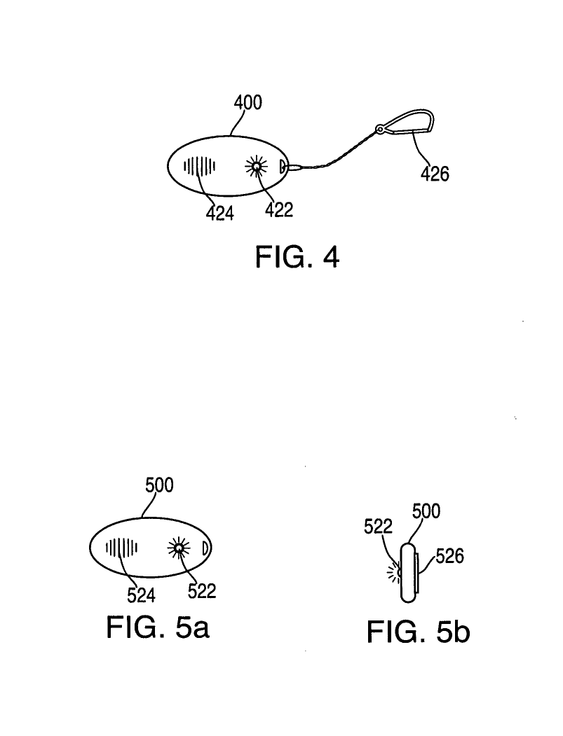

FIG. 4 includes device 400 in the form of an attachable device in accordance with the principles of the present invention. Device 400 can be attached to objects (e.g. keys, etc.) to aid in locating those objects should they be lost. Device 400 can include clip 426 for attaching device 400 to another object. Device 400 can have light 422 and speaker 424 which function similar to the corresponding features of device 320. The attachable nature of device 400 allows a user to attach it to any object to be located even if that object is not electronic in nature. As described in more detail below, device 400 can also be referred to as slave device 400. Once a master device has been paired to slave device 400, a user can create or edit an identifying name in the master device's user interface to correspond to the object that device 400 has been attached to.

FIGS. 5a and 5b include device 500 in the form of another attachable device in accordance with the principles of the present invention. FIG. 5a shows a front view of device 500, and FIG. 5b shows a side view of device 500. Device 500 can be attached to an object using adhesive 526. Adhesive 526 can be useful when attaching device 500 to objects with smooth outer surfaces and nothing to clip onto (e.g., remote controls, etc.). As described in more detail below, device 500 may also be referred to as slave device 500.

Master device 310 can be paired, using a Bluetooth protocol, with one or more slave devices. Master device 310 can keep a record of the various slave devices to which the master device is paired. A user can be given the ability to create unique names or other identifiers for the slave devices through the master device's user interface. It is contemplated that a user can set-up the configuration using software on a computer and then transfer the information to a master device. After the devices have been paired, the master device can automatically alert a user whenever one of the slave devices is leaving the effective range of communication.

After being paired together, devices may not necessarily be used for an extended period of time. When a user wants to locate one of the slave devices 320, 400 and 500, the user can initiate the location discovery process through master device 310. Master device 310 can transmit a signal to a slave device. Upon receiving the signal, the slave device can guide a user to its location and/or notify a user of the distance from master device 310 to the slave device. It is contemplated that a slave device can also be used to locate a master device. In that instance, a user can initiate the location discovery process using, for example, a button on a slave device and the master device can guide the user to its location.

In one embodiment, slave devices 320, 400 and 500 can guide a user to their location by emitting auditory or visual signals. This embodiment allows a user to follow the sound or light to the misplaced object. To save power, the signals can be cycled on and off repeatedly. It may also be desirable to have the signals cycle according to an increasingly longer duty cycle. This means that the length of the signals can become longer while the frequency of the signals remains the same.

In another embodiment, slave devices 320, 400 and 500 can notify a user of the distance between the slave device and master device 310. This can include transmitting a return signal to master device 310. Master device 310 can then calculate the distance to the slave devices. The results of this calculation can be presented to a user through a graphical display on screen 316.

The distance between the devices can be calculated by comparing the amount of time delay between the transmission of the signal sent from the master device to the slave device and the reception of the return signal from the slave device. With a precise timing system, the master device can be capable of performing such measurements. Since the speed of the radio waves is known, the distance can be calculated using the time information. The average time it takes the slave device to respond after receiving a signal can also be used to compensate the time delay. Alternatively, the distance between the two devices can be calculated by switching the amount of power used to transmit signals and measuring the comparative strength of the received signals.

Once this distance is calculated, it can be displayed to the user through graphics on the master device. This information can also affect an auditory or visual signal emitted by the slave device. For example, a beeping alarm might change in pitch, rate of beeping, or volume as a user approaches a second device. In that instance, the beeping could get faster as the user gets closer to the missing device, or the sound could get louder as the user gets closer.

In another embodiment, directional antennas can be used to determine the direction towards a slave device from the master device. This information can be presented to a user through a graphical interface on the master device's screen to direct the user to the missing slave device.

In still another embodiment, the slave device's location can be determined and presented to the user through the master device. Calculating the slave device's location can involve using multiple transmitters or receivers to triangulate the position of the missing device. In order to triangulate position, a system can determine the distances from a device to at least three other known locations. A Global Positioning System, for example, could be used to triangulate a device's location in accordance with the principles of the present invention. It is further contemplated that systems using other RF signal types can triangulate a device's location in accordance with the principles of the present invention. Once the slave device's location has been determined, the information could then be transmitted to the master device and displayed to the user.

It may also be desirable for a master device to triangulate its own position. In this instance, knowing the location of both devices could allow the system to calculate additional information. For example, the distance between the devices, the heading from the master device to a slave device, and the speed at which the master device is moving towards the slave device can be calculated once both locations are known.

In another embodiment, determining a slave device's relative location can involve using more than one master device and determining the distance of the slave device to each master device. By comparing the distances, the approximate location of the slave device can be determined.

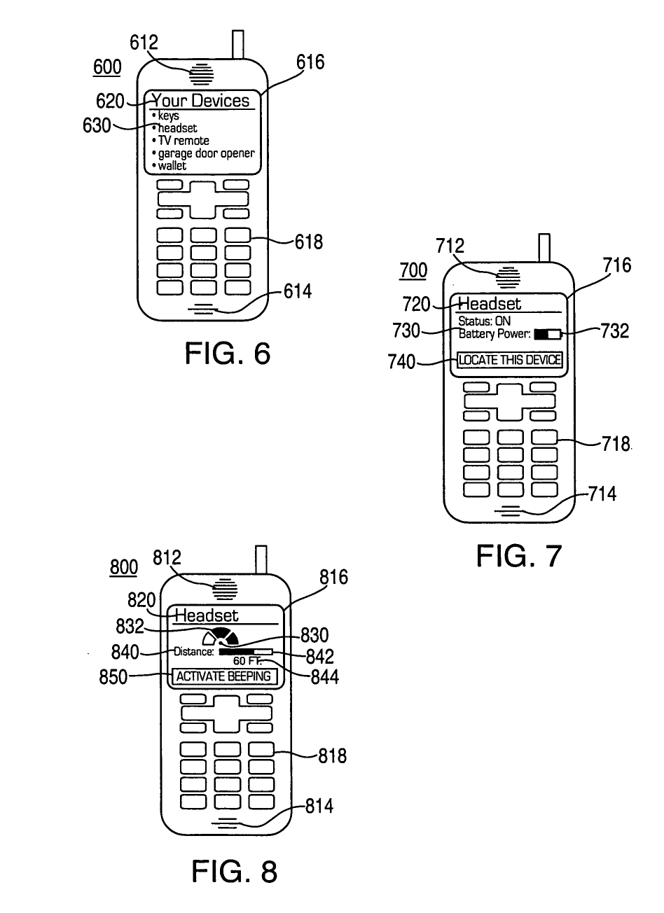

FIG. 6 includes a screenshot of the user interface of master device 600. Device 600 can include speaker 612, microphone 614, screen 616 and keypad 618. Screen 616 can include title 620 to identify the information displayed. Screen 616 can also include list 630 of the slave devices that are associated with master device 600. List 630 can be automatically filtered to only include those devices which are paired and within range of master device 600. Device 600 can permit a user to select a slave device from list 630. Any user input in accordance with the principles of the present invention can be delivered through speech into microphone 614 which can be recognized by a voice recognition system in device 600. In accordance with the principles of the present invention, such input can also be prompted or confirmed by an audio signal or via synthesized speech emanating from speaker 612 in master device 600.

FIG. 7 includes a screenshot of the user interface of master device 700 after a slave device has been selected. Device 700 can include speaker 712, microphone 714, screen 716 and keypad 718. Screen 716 can include title 720 to identify the selected slave device. Screen 716 can also include status information 730 about the selected slave device. Status information can include the state of the slave device (e.g., on, standby, out-of-range, etc.). Status information can also include, for example, battery power information if applicable. The status information can be displayed using various graphical representations, such as battery power meter 732. Screen 716 can include graphical button 740 to enable the user to prompt master device 700 to locate the selected slave device.

FIG. 8 includes a screenshot of the user interface of master device 800 when the master device is attempting to locate a slave device. Screen 816 can include title 820 to identify the selected slave device. Screen 816 can include directional graphic 830 to indicate to the user the direction where the slave device should be located. Directional graphic 830 can include, for example, quadrants 832 which represent different areas in front of master device 800. Quadrants 832 can change so as to distinguish the area where the slave device is. Screen 816 can include distance graphic 840 to identify the distance between the selected slave device and master device 800. Distance graphic 840 can include a symbolic representation 842 of distance, for example, a horizontal bar graphic or a numeric representation of distance 844. Screen 816 can include graphical button 850 to enable the user to prompt the slave device to beep, flash or perform a combination of both, or provide some other indication.

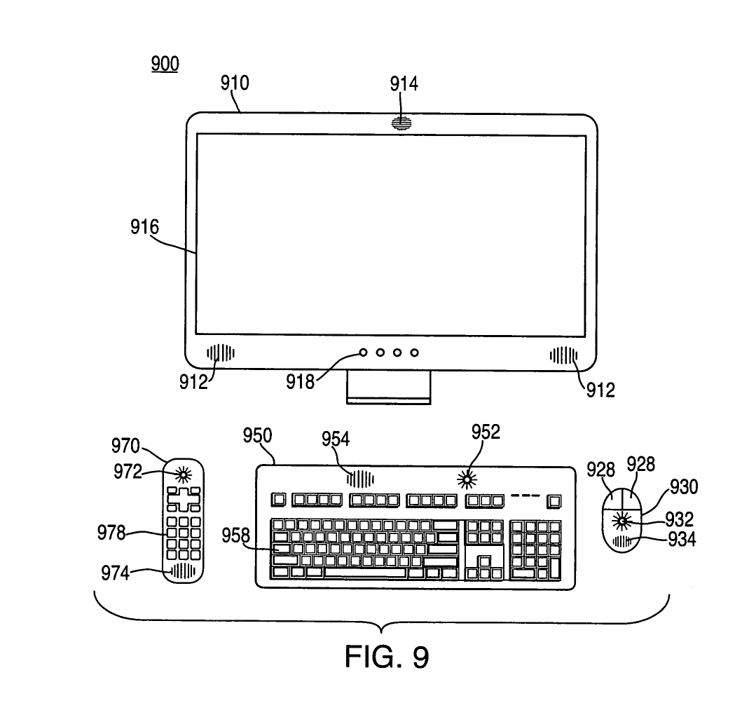

FIG. 9 is an illustration of an embodiment of a location discovery system 900 in accordance with the principles of the present invention. System 900 includes master device 910 and slave devices 930, 950 and 970. Master device 910 can be a computer with other functions besides location discovery. Computer 910 can include speakers 912, microphone 914, screen 916 and buttons 918. Computer 910 can be Bluetooth capable and can be paired to slave devices such as wireless keyboards, wireless computer mice, remote controls, etc. If one of the slave devices becomes lost, a user can initiate the location discovery process using buttons 918. Each button can be assigned to a different device so that a user only needs to press the button corresponding to the lost device. It is also contemplated that users can initiate the location discovery process using a different type of input, such as speech commands.

Slave device 930 can be a computer mouse for use with computer 910. Computer mouse 930 can include light 932, speaker 934 and buttons 928. If mouse 930 becomes lost, light 932 and speaker 934 can attempt to guide a user to its location.

Slave device 950 can be a computer keyboard for use with computer 910. Keyboard 950 can include light 952, speaker 954 and buttons 958. If keyboard 950 becomes lost, light 952 and speaker 954 can attempt to guide a user to the its location.

Slave device 970 can be a remote control for use with computer 910 or other electronics (e.g. television, DVD player, stereo). Remote control 970 can include light 972, speaker 974 and buttons 978. If remote control 970 becomes lost, light 972 and speaker 974 can attempt to guide a user to the its location. Slave devices 930, 950 and 970 can use other interfaces, in addition to Bluetooth, to communicate with computer 910. Mouse 930, keyboard 950, and remote control 970 are provided for purposes of illustration rather than of limitation. One of ordinary skill in the art will appreciate that other types of devices may be used as slave devices in accordance with the principles of the present invention.

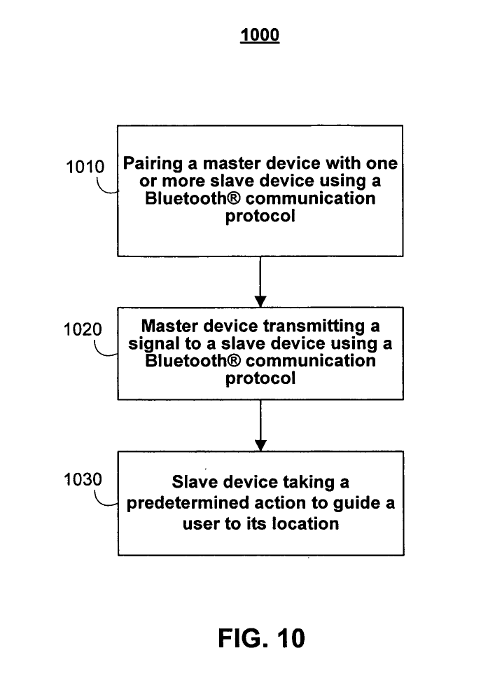

FIG. 10 is a flowchart of method 1000 for locating an object. At step 1010, a master device is paired with one or more slave devices using a Bluetooth communications protocol. Once two devices are paired, method 1000 can remain in between step 1010 and step 1020 for an indefinite period of time. Method 1000 can be manually instructed to proceed by a user or can proceed automatically if a slave device becomes lost. At step 1020, the master device transmits a signal to a slave device using a Bluetooth communications protocol. At step 1030, the slave device takes a predetermined action to guide a user to its location. The predetermined action could be, for example, turning on a light, emitting a sound, or transmitting a signal back to the master device with information about the slave device's location.

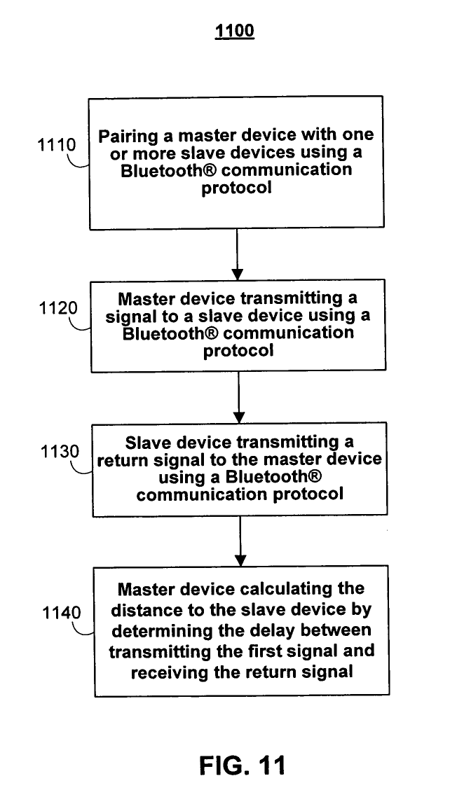

FIG. 11 is a flowchart for method 1100 for locating an object. At step 1110, a master device is paired with one or more slave devices using a Bluetooth communications protocol. At step 1120, the master device transmits a signal to a slave device using a Bluetooth communications protocol. At step 1130, the slave device transmits a return signal to the master device using a Bluetooth communications protocol. At step 1140, the master device calculates the distance to the slave device by determining the amount of time delay between transmitting its signal to the slave device and when it receives a return signal from the slave device. The master device can use the known speed of radio waves and the known response time of the slave device when calculating the distance. Once this distance is determined it can be displayed to a user through a graphical interface on the master device.

Thus it is seen that descriptions of a location discovery system and method are provided. A person of ordinary skill in the art will appreciate that the present invention may be practiced by other than the described embodiments, which are presented for purposes of illustration rather than of limitation.

What is claimed is:

1. A system comprising:
a master device capable of transmitting a signal using a Bluetooth communications protocol; and
a slave device capable of receiving a signal using a Bluetooth communications protocol, wherein the slave device is operable to guide a user to its location when prompted to by a Bluetooth transmission from the master device.

2. The system of claim 1 wherein the slave device comprises a speaker and the slave device is operable to guide the user to its location by emitting an auditory signal from the speaker.

3. The system of claim 1 wherein the slave device comprises a light and the slave device is operable to guide the user to its location by emitting a visual signal from the light.

4. The system of claim 1 wherein the slave device is operable to guide the user to its location using a wireless communication to the master device.

5. The system of claim 1 wherein the slave device is operable to determine its location and transmit that location to the master device.

6. The system of claim 1 wherein the master device is a cellular telephone.

7. The system of claim 1 wherein the slave device is an electronic device with a primary function other than location discovery.

8. The system of claim 1 wherein the slave device is an electronic device that is operable to attach to another object.

9. A system comprising:
a master device capable of transmitting a signal using a Bluetooth communications protocol; and
a slave device capable of receiving a signal using a Bluetooth communications protocol, wherein one of the devices is operable to determine the distance between the two devices by analyzing the timing of Bluetooth communications between the two devices.

10. The system of claim 9 wherein the master device is operable to determine the distance to the slave device by determining the time delay between transmitting a signal to the slave device and receiving a return signal from the slave device.

11. A method comprising:
a master device transmitting to a slave device using a Bluetooth communications protocol; and
a slave device taking a predetermined action to guide user to its location.

12. The method of claim 11 wherein the slave device guides the user to its location by emitting an auditory signal.

13. The method of claim 11 wherein the slave device guides the user of its location by emitting a visual signal.

14. The method of claim 11 wherein the slave device guides the user to its location by transmitting a return signal to the master device using a wireless communications protocol.

15. The method of claim 11 wherein the slave device guides the user to its location by determining its location and transmitting that location to the master device.

16. The method of claim 11 wherein the master device is a cellular telephone.

17. The method of claim 11 wherein the slave device is an electronic device with a primary function other than location discovery.

18. The method of claim 11 wherein the slave device is an electronic device that attaches to another object.

19. A method comprising:
a master device transmitting to a slave device using a Bluetooth communications protocol;
a slave device transmitting to the master device a return signal using a Bluetooth communications protocol; and
the master device determining the distance to the slave device.

20. The method of claim 19 wherein the master device determines the distance to the slave device by analyzing the timing of Bluetooth communications between the two devices.

21. The method of claim 20 wherein the master device calculates the distance to the slave device by determining the delay between transmitting the signal to the slave device and receiving a return signal from the slave device.

22. A device comprising a circuit operable to communicate using a Bluetooth communications protocol, wherein the device is operable to guide a user to its location when prompted to by a Bluetooth transmission from another device.

23. The device of claim 22 further comprising a speaker operable to guide a user to its location by emitting an audio signal.

24. The device of claim 22 further comprising a light operable to guide a user to its location by emitting a visual signal.

25. A device comprising:
a circuit operable to communicate using a Bluetooth communications protocol; and
a circuit operable to analyze timing of Bluetooth communications with another device in order to determine the distance between the device and another Bluetooth enabled device.
